(19) United States
(12) Patent Application Publication
(10) Pub. No.: US 2013/0162940 A1
(43) Pub. Date: Jun. 27, 2013

(54) Spectacles With Removable Optics

(71) Applicants: Stephen Kurtin, Sherman Oaks, CA (US); Scott Edward Winslow, Tujunga, CA (US)

(72) Inventors: Stephen Kurtin, Sherman Oaks, CA (US); Scott Edward Winslow, Tujunga, CA (US)

(73) Assignee: Zoom Focus Eyeware, LLC, Van Nuys, CA (US)

(21) Appl. No.: 13/727,099

(22) Filed: Dec. 26, 2012

Related U.S. Application Data
(60) Provisional application No. 61/631,098, filed on Dec. 27, 2011.

(51) Int. Cl. G02C 9/04

(52) U.S. Cl. CPC G02C 9/04
USPC 351/57

(57) ABSTRACT

Spectacles having two frames magnetically coupled together, the first frame having a pair of temples, and the second frame, located behind the first frame having nosepads. The bridge of the first frame has a rear opening cavity to accept and keep in alignment, the bridge of the second frame. Magnetic means within the rear opening cavity holds the two frames together.

### RELATED APPLICATIONS

This application claims the benefit under 35 USC §119(e) of the filing date of U.S. Provisional Patent Application Ser. No. 61/631,098, entitled “Spectacles With Removable Optics” filed on Dec. 27, 2011. By this reference, the contents of Application Ser. No. 61/631,098 are incorporated herein in their entirety.

### BACKGROUND OF THE INVENTION

Presbyopia is the loss of visual accommodation suffered by most people as a natural consequence of aging. A person whose visual accommodation is less than about 2.50 diopters finds it difficult to both focus on distant objects, and read books, newspapers, and the like. In order to combat this lack of accommodation, spectacle lenses having more than one optical power are typically prescribed. Most conveniently, the optical power should be continuously variable.

Historically the visual needs of presbyopes have been met by use of multiple pairs of single vision eyeglasses, or by spectacles having bifocal, trifocal, or progressive addition lenses. None of the foregoing is entirely satisfactory. More recently, to better serve the visual needs of presbyopes, true variable focus eyeglasses have been developed. One such development is described in U.S. Pat. No. 7,866,816.

The glasses shown in U.S. Pat. No. 7,866,816, however, do not provide the cosmetic versatility of conventional spectacles. The glasses of the present invention retain the optical advantages of the '816 patent, but permit substantially wider stylistic latitude.

### SUMMARY OF THE INVENTION

In one aspect, the present invention includes a spectacle frame to which a ‘focus module’ is removably coupled. The spectacle frame may carry conventional eyeglass lenses, e.g., plano, single vision, bifocal, or progressive lenses. The focus module is a second frame, fastened behind the spectacle frame, and may include either fixed or variable focus lens units. The invention is illustrated by an embodiment including the latter, and hence the second frame is usually called a focus module herein. The spectacle (or “front” or “first”) frame is referred to simply as “the frame” herein. For ease in explanation, directions referred to herein are stated relative to a wearer of the glasses. Rearward, behind, and similar references refer to the direction toward a wearer's face.

While the invention is illustrated in connection with a focus module having lens units that provide continuously variable optical power, and so is very useful to presbyopes, it is not limited to that application. Inasmuch as the variable focus aspects of the focus module herein illustrated are not part of the invention, they are not described here in detail.

Nevertheless details of at least one embodiment of variable focus eyeglasses that includes a suitable variable focus module, is disclosed in U.S. Pat. Nos. 7,866,816 and 7,008,054, the disclosures of which are included here in their entireties by reference.

In a presently preferred embodiment of the invention, the focus module preferably has an optical power in each lens unit that can be adjusted by the wearer over the range, for example, of about 0 to about +2.75 diopters. This range permits a user to focus, for example, on distant objects as well as on books etc. at a comfortable reading distance. An actuator that enables (simultaneous) adjustment of both lens units is located within a bridge that connects the two of them to each other. The term “lens unit” refers to one of the two lens assemblies that are included in the focus module.

In this preferred embodiment, the frame does not include nosepads; instead nosepads are attached to the focus module bridge, preferably via pad arms, i.e., nosewires. Attaching the nosepads to the focus module, instead of to the frame, is preferred because it allows forces applied by the user (as when adjusting focus) to be more nearly directly borne by the user's nose, without need to be transmitted via the frame. While not carrying nosepads, the frame does preferably have temples attached.

The bridge of the frame preferably has a rear facing cavity that physically mates with the focus module bridge. The mating is such that the focus module can be removed by sliding it rearward. The focus module is retained in position vis-a-vis the frame preferably by the use of two pairs of rare earth magnets, one magnet of each pair located on, or within, said frame and the other preferably located on, or within, the focus module bridge. Consequently the focus module can be conveniently attached to the frame, will be securely held in place when in use and yet, when desired, can be easily removed by appropriately applied front-to-back finger force. While retention is described using pairs of magnets, it will be appreciated that the pairs could also consist of a magnet and a piece of ferromagnetic metal.

Since in the preferred embodiment the frame does not include nosepads, its use without a focus module installed may be accomplished through the use of a ‘focus module surrogate’. A focus module surrogate preferably consists of a bridge-like element, which magnetically couples to the frame, into which pad arms and nosepads have been installed.

### BRIEF DESCRIPTION OF THE DRAWINGS

FIG. 1 is a perspective view of a pair of spectacles including the present invention, shown with a variable focus module attached.

FIG. 2 is a top view of the spectacles of FIG. 1 showing a variable focus module separated from the frame.

FIG. 3 (A, B, and C) are cross sectional views of the spectacles of FIG. 2 taken at 3-3 of FIG. 2 (through the magnets). The figure shows only the cut surfaces and not the surrounding details. FIG. 3A shows the frame; FIG. 3B shows the focus module; and FIG. 3C shows the focus module inserted into, and mated with, the frame.

FIG. 4 (A, B, and C) are cross sectional views of the eyeglasses of FIG. 2 taken at 4-4 of FIG. 2 (through the center of the bridge). The figure shows only the cut surfaces and not the surrounding details. Following the convention of FIG. 3: FIG. 4A shows the frame; FIG. 4B shows the focus module; and FIG. 4C shows the focus module inserted into, and mated with, the frame.

FIG. 5 is a fragmentary rear perspective view of the bridge region of the focus module and of the frame, the focus module being positioned a short distance away from, and aligned with, the frame. {Note: since this figure is a rear view, the magnets bonded into the focus module bridge cannot be seen.}

FIG. 6 is a fragmentary rear perspective view of the bridge region of a focus module surrogate and a frame, the focus module surrogate being positioned a short distance away from, and aligned with, the frame. {Note: since this figure is a rear view, the magnets bonded into the focus module surrogate bridge cannot be seen.}

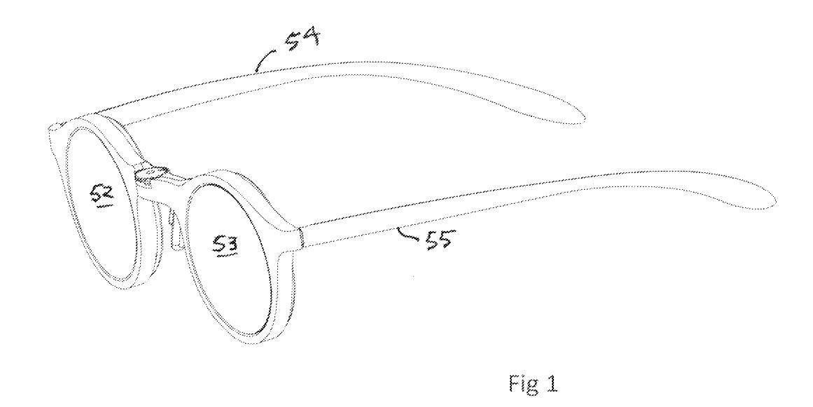

### DETAILED DESCRIPTION OF THE INVENTION

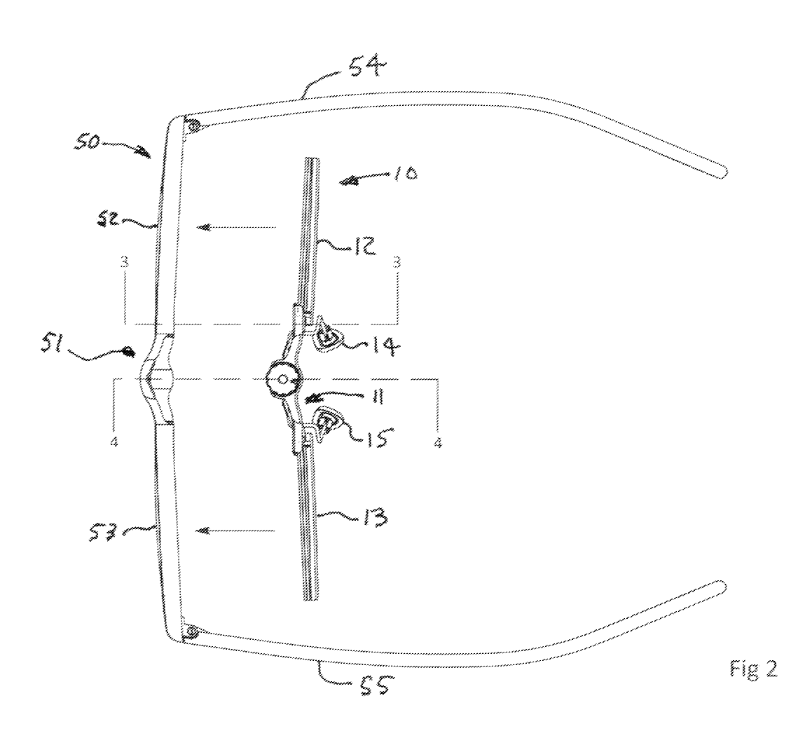

FIG. 2 shows a top view of a variable focus module 10 in position to be attached to a frame 50. The focus module bridge 11 (which in the illustrated embodiment contains an actuator that is not described herein) is aligned with bridge 51 of frame 50, causing lens units 12 and 13 to be aligned with conventional lenses 52 and 53 in the frame. The focus module is shown fitted with nosepads 14 and 15, and the frame includes temples 54 and 55. It is possible for nosepads to be directly attached to the frame (and it is also possible to attach temples to the focus module), but the illustrated structure is the presently preferred arrangement.

The magnet pairs are shown located in the bridge area, but it will be appreciated that they could (alternatively or incrementally) be located near the temples or elsewhere on the face of the spectacles, as may be convenient.

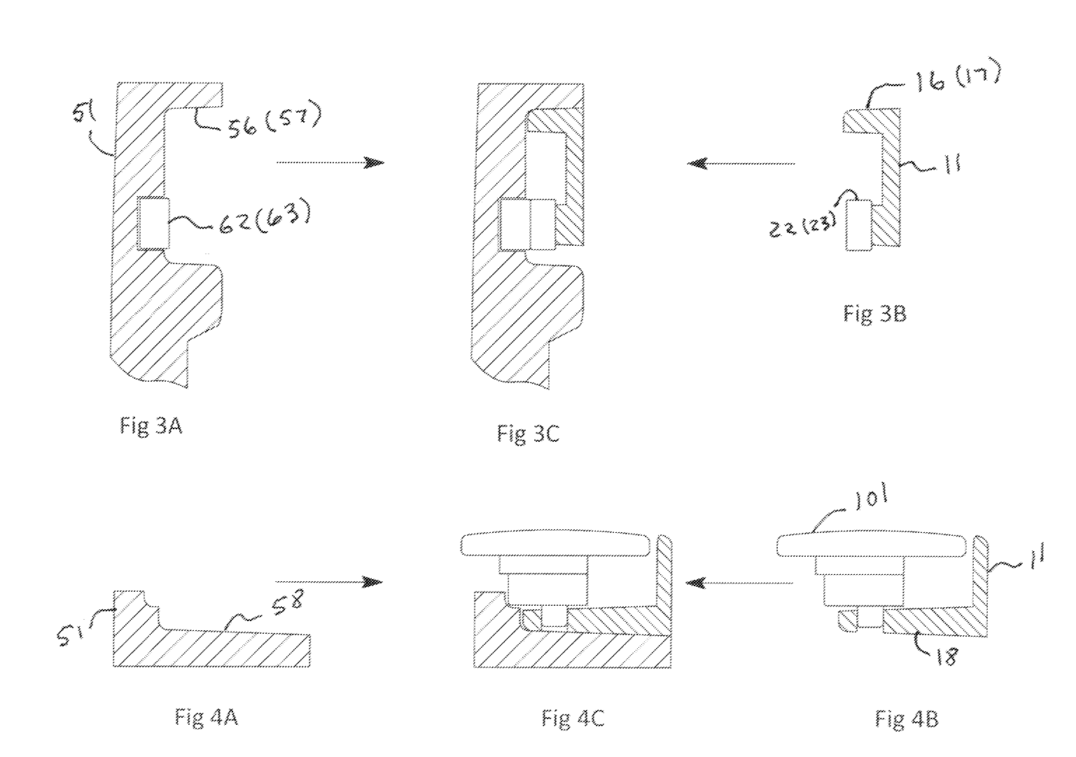

FIG. 3 includes cross sectional views of bridges 11 and 51, (separated in FIGS. 3A and 3B, and together in FIG. 3C), taken at a location near the end of the focus module bridge, at the location of the magnets in this preferred embodiment. Each bridge is itself preferably substantially symmetrical; hence a section taken near either end of the bridge will appear substantially as illustrated in FIG. 3.

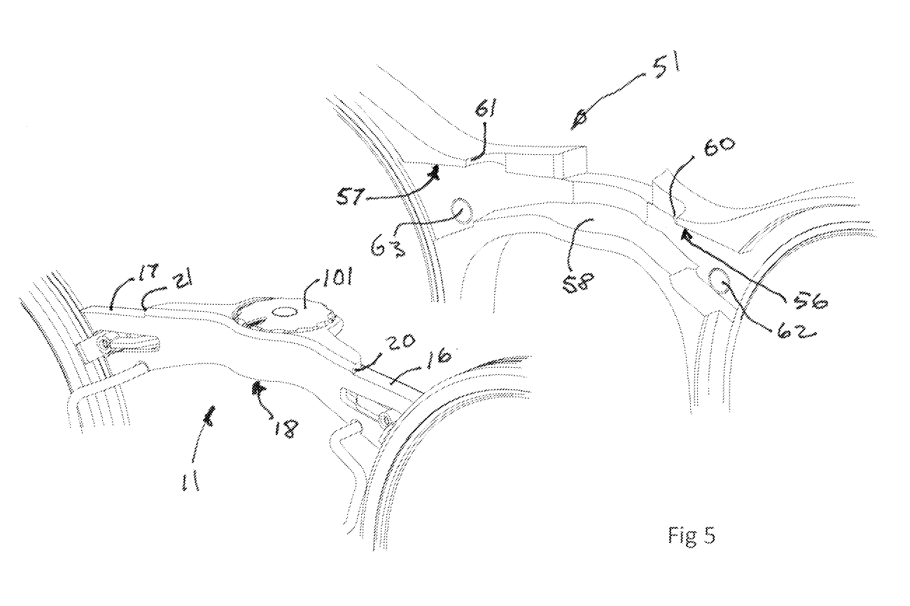

FIG. 4 is a cross sectional view similar to FIG. 3 except taken at the center of the focus module bridge. Bridge 51 has a more or less U-shaped horizontal cavity in its rear surface (i.e., the “U” is lying on its side). Describing the cavity shape as being a horizontal “U” is intended to be evocative and not literal, since it is not necessary that both legs of the “U” occur at any one section. I.e., the top and bottom of the cavity may be ‘discontinuous’ segments, by which we mean that the top and bottom surface segments of the “U” (which surface segments mate with corresponding surfaces on the focus module) need not occur in one plane. Hence the top of the “U” opening 56 can be seen in FIG. 3 but not in FIG. 4, whereas the bottom 58 can be seen in FIG. 4 but not in FIG. 3. Similarly, the surface segments of focus module bridge 11 that mate with bridge 51 may be discontinuous. Hence top surface segment 16 can be seen only in FIG. 3, whereas the bottom surface segment 18 can be seen only in FIG. 4.

When the two bridges are placed together, surface segments of the focus module bridge 11 are located near and parallel to corresponding surface segments of bridge 51, resulting in a male/female interlock that provides mutual vertical, lateral and rotational support.

For example—as shown in FIGS. 3C and 4C—surface segment 18 mates with surface segment 58, surface segment 16 mates with surface segment 56, and surface segment 17 mates with surface segment 57. The result is vertical and rotational mating support. The number and location of the surface segments that locate the focus module with respect to the frame is intended to be at the discretion of the designer; indeed, the frame may be solid or cut away between the locating surface segments, as desired. Note: Item 101, seen in FIGS. 4B and 4C, is part of one form of actuator and hence is not described here.

Similarly, lateral location of bridge 51 with respect to the focus module bridge is, in this embodiment, provided primarily by the “keying” action of surfaces 20 and 21 into the opening between surfaces 60 and 61 on the frame (FIG. 5).

Retention of the focus module to the frame 51 is preferably provided by one or more pairs of magnets, preferably located within the bridge region. In the presently preferred embodiment of the invention, as illustrated, two rare earth magnets 62 and 63 are adhesively bonded to frame 51, and are therefore available to magnetically latch with corresponding rare earth magnets 22 and 23 adhesively bonded to the focus module bridge. Magnet 23, which is not visible in the drawings, is located symmetrically about the centerline of the focus module bridge with respect to magnet 22. The mating pairs need not both be magnets, one of each pair could be, for example, a piece of ferromagnetic material.

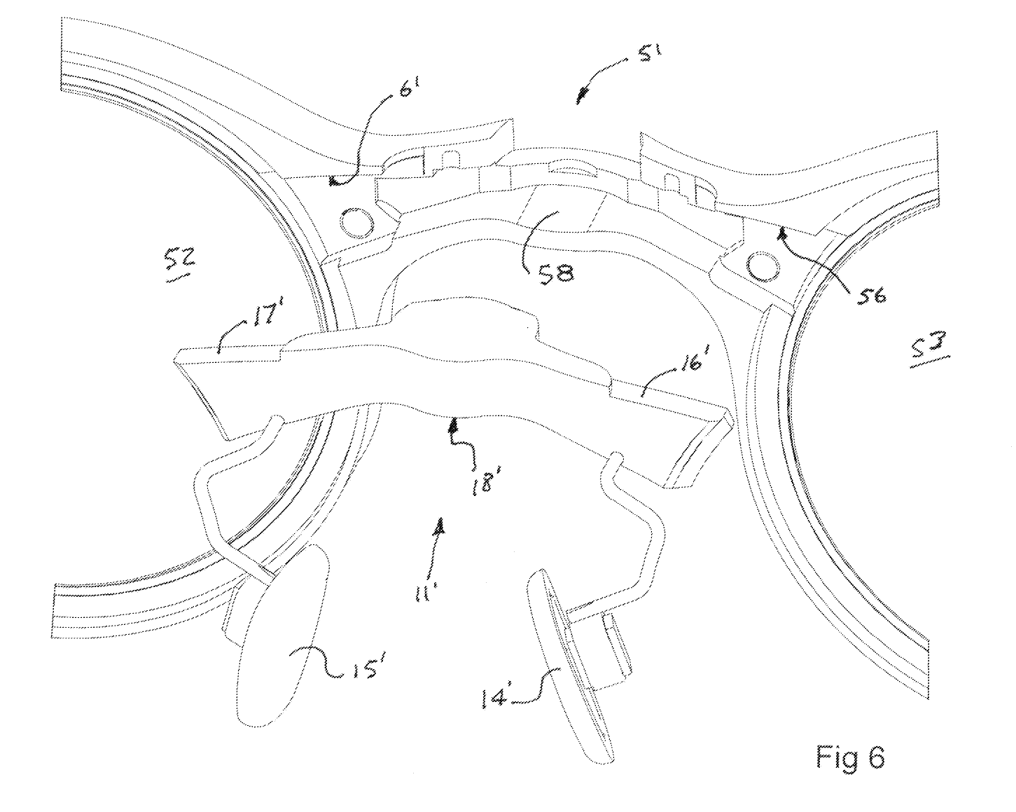

FIG. 6 shows a frame 51 as described above in connection with the first embodiment of the invention disclosed herein, to which a “focus module surrogate” 11′ is used instead of an actual focus module. A focus module surrogate is comprised mainly of a bridge similar to the bridge of a focus module, but having no lens units or actuator. The focus module surrogate includes nosepads 14′ and 15′, perhaps identical to the nosepads 14 and 15 used in connection with focus module 11, and also includes surfaces 16′, 17′ and 18′ that mate with surfaces 56, 61 and 58 of a frame 51 similar to the mating of a focus module and frame as described above. Not seen in FIG. 6 are the attachment magnets corresponding to magnets 22 and 23 of the first embodiment. These magnets are present in the same locations as in the focus module described above, but are not seen because of the views shown. A focus module surrogate 11′ attached to frame 51 forms a pair of spectacles which resembles conventional spectacles having lenses 52 and 53 that can be, for example, single vision or zonal multi-focal (bifocals, trifocals, or progressive).

What have been described are the presently preferred embodiments of spectacles that include means for holding a detachable focus module or a focus module surrogate. Various modifications of the invention as described herein will no doubt occur to those skilled in the art; all such modifications as fall within the letter and spirit of the claims which will be appended to the non-provisional application that is intended subsequently to be filed are intended to be covered thereby.

We claim:

1. A pair of spectacles comprising:
a first frame including two first lenses and a bridge between said two first lenses;
a pair of temples attached to said first frame;
a second frame including two second lenses and a bridge between said two second lenses;
a pair of nosepads attached to said second frame; and
means for removably attaching said second frame to said first frame.

2. A pair of spectacles as recited in claim 1 where said nosepads are attached to said second frame via nosewires.

3. A pair of spectacles as recited in claim 1 wherein said second frame is attached to said first frame behind said first frame.

4. A pair of spectacles as recited in claim 3 wherein said second frame is attached to said first frame by magnetic means.

5. A pair of spectacles as recited in claim 4 where said magnetic means include magnetic elements on the bridges of said first and second frames.

6. A pair of spectacles comprising:
a first frame including two first lenses and a first bridge between said two first lenses;
a second frame including two second lenses and a second bridge between said two second lenses; and
means for removably attaching said second frame behind said first frame; where
said first bridge includes a rearward opening cavity to accept said second bridge.

7. A pair of spectacles as recited in claim 6 wherein said rearward opening cavity has top and bottom surfaces, and said top and/or said bottom surface has an opening therein.

8. A pair of spectacles as recited in claim 6 wherein at least two magnetic members are positioned within the interior of said rearward opening cavity.

9. A pair of spectacles comprising:
a first frame including two first lenses and a first bridge between said two first lenses;
a pair of temples attached to said first lenses respectively;
a second frame including two second lenses and a second bridge between said two second lenses;
a pair of nosewpads attached to said second frame;
means for removably attaching said second frame behind said first frame; where
said first bridge includes a rearward opening cavity to accept said second bridge.
